(19) United States
(12) Patent Application Publication
(10) Pub. No.: US 2026/0297407 A1
(43) Pub. Date: Oct. 1, 2026

(54) COMPOSITIONS

(71) Applicant: MEXICHEM UK LIMITED, Runcorn (GB)

(72) Inventors: Robert E. LOW, Ince (GB); Christopher J. SEETON, Waltham, MA (US)

(21) Appl. No.: 19/474,846

(22) PCT Filed: Apr. 12, 2024
(86) PCT No.: PCT/GB2024/050956

§ 371 Date: Oct. 13, 2025

Related U.S. Application Data
(60) Provisional application No. 63/496,097, filed on Apr. 14, 2023.

(30) Foreign Application Priority Data
May 24, 2023 (GB) 2307781.1

(51) Int. Cl. C09K 5/04

(52) U.S. Cl. CPC C09K 5/045; C09K 2205/106; C09K 2205/126

(57) ABSTRACT

According to the present invention, there is provided a composition comprising: (a) 1,1-difluoroethylene (R-1132a); (b) difluoromethane (R-32) (c) trans-1,2-difluoroethylene (R-1132(E)); and (d) one or more of trans-1,3,3,3-tetrafluoropropene (R-1234ze(E)), 1,1-difluoroethane (R-152a) and 2,3,3,3-tetrafluoropropene (R-1234yf).

The invention relates to compositions, preferably to heat transfer compositions which may be suitable as replacements for existing refrigerants, such as R-410A and/or R-454B.

The listing or discussion of a prior-published document or any background in the specification should not necessarily be taken as an acknowledgement that a document or background is part of the state of the art or is common general knowledge.

Mechanical refrigeration systems and related heat transfer devices such as heat pumps and air-conditioning systems are well known. In such systems, a refrigerant liquid evaporates at low pressure taking heat from the surrounding zone. The resulting vapour is then compressed and passed to a condenser where it condenses and gives off heat to a second zone, the condensate being returned through an expansion valve to the evaporator, so completing the cycle. Mechanical energy required for compressing the vapour and pumping the liquid is provided by, for example, an electric motor or an internal combustion engine.

R-410A is a non-flammable binary mixture of refrigerants R-32 and R-125, and currently is the dominant refrigerant used for comfort cooling and heating in residential and light commercial building HVAC systems worldwide. Its high Global Warming Potential (GWP) of 2088 means it would be desirable to replace this refrigerant with one having similar thermodynamic properties and performance characteristics to R-410A and a having a lower GWP. Particularly important characteristics are the operating pressure, volumetric cooling capacity, compressor exit temperature, pressure drop and energy efficiency, expressed as Coefficient of Performance (COP).

Currently proposed alternative refrigerants which have lower GWP than R-410A include R-32 (GWP of 675), R-454B (GWP of 466) and R-468C (GWP of 284). All these refrigerants are flammable, and their flammability is classified by ASHRAE SSPC34 methodology as “2L”, meaning that the burning velocity is less than 10 cm/s, and the energy of combustion is less than 19 MJ/kg. System designs, appliance design standards and fire safety codes now recognise and provide for use of such flammable refrigerants in residential and commercial air-conditioning systems. Therefore, it is desirable that any new refrigerant intended as a replacement refrigerant also be classified as “2L” flammable.

Although the GWP of R-32, R-454B and R-468C is lower than that of R-410A, there is still a need for alternatives which have yet lower GWP.

Refrigerants R-454C (R-32 31.5%, R-1234yf 78.5%) and R-455A (CO₂ 35%, R-32 21.5%, R-1234yf 75.5%) all have a GWP below 150 and a similar vapour pressure to R-407C and propane (R-290), so could be used as air-conditioning refrigerants. However, their properties are too dissimilar to those of R-410A/R-32/R-454B to allow ready adaptation of equipment designs.

Refrigerants such as R-454B, R-454C, R-455A are formulated using R-1234yf. Even though R-1234yf has desirable performance characteristics, it has been found to break down rapidly in the environment with 100% molar yield to form trifluoroacetic acid (TFA). TFA is toxic and is very resistant to environmental degradation. The large-scale replacement of R-410A with R-454B would lead to an increase in levels of TFA in groundwater. Therefore, it would be desirable to develop new refrigerants that will generate less TFA on release to the environment than R-454B.

Thus, there is a need to provide alternative refrigerants having improved properties such as low GWP (so as to reduce the environmental impact of refrigerant leakage), yet possessing acceptable refrigeration performance, flammability characteristics and toxicology. There is also a need to provide alternative refrigerants that may be used in existing devices such as refrigeration devices with little or no modification.

More specifically, it would be desirable to develop a refrigerant composition suitable for use as a replacement for R-410A, R-32 or R-454B in unitary air-conditioning or heat pump systems, which composition has adequately low GWP and physical properties that are sufficiently close to those of R-410A or R-454B that the existing equipment design may be readily adapted to the use of the composition. More preferably, the composition would also be weakly flammable and more environmentally friendly than R-454B in terms of at least the standpoint of TFA generation.

The subject invention addresses the above and other deficiencies/needs, by the provision of a composition comprising 1,1-difluoroethylene (R-1132a), difluoromethane (R-32), trans-1,2-difluoroethylene (R-1132(E)) and one or more of trans-1,3,3,3-tetrafluoropropene (R-1234ze(E)), 2,3,3,3-tetrafluoropropene (R-1234yf) and 1,1-difluoroethane (R-152a). Such compositions are referred to hereinafter as compositions of the invention.

Typically, the R-1132a is present in the compositions of the invention in an amount of from about 1 to about 20% by weight, such as from about 2 to about 20% by weight, for example from about 3 to about 20% by weight, preferably from about 4 to about 18% by weight, such as from about 4 to about 16% by weight.

The compositions of the invention typically contain R-32 in an amount of from about 1 to about 50% by weight, such as from about 5 to about 45% by weight, for example from about 7 to about 40% by weight, preferably from about 10 to about 30% by weight, such as from about 12 to about 25% by weight.

The R-1132(E) is typically present in the compositions of the invention an amount of from about 1 to about 60% by weight, such as from about 5 to about 55% by weight, for example from about 10 to about 50% by weight or from about 15 to about 45% by weight, preferably from about 18 to about 45% by weight. It has been surprisingly found that, by including R-1132(E) in these amounts, it is possible to formulate compositions having improved volumetric refrigeration capacity without compromising the GWP.

The one or more of R-1234ze(E), R-152a and R-1234yf may be present in the compositions of the invention in an amount of from about 1 or 2 to about 75% by weight, such as from about 5 to about 70% by weight, for example from about 5 to about 65% by weight, preferably from about 10 to about 65% by weight.

Typically, the compositions of the invention comprise from about 1 to about 20% by weight R-1132a, from about 1 to about 50% by weight R-32, from about 1 to about 60% by weight R-1132(E) and from about 1 or about 2 to about 75% by weight of the one or more of R-1234ze(E), R-152a and R-1234yf.

Conveniently, the compositions of the invention comprise from about 2 to about 20% by weight R-1132a, from about 5 to about 45% by weight R-32, from about 5 to about 55% by weight R-1132(E) and from about 5 to about 70% by weight of the one or more of R-1234ze(E), R-152a and R-1234yf.

For example, the compositions of the invention comprise from about 3 to about 20% by weight R-1132a, from about 7 to about 40% by weight R-32, from about 10 to about 50% by weight R-1132(E) and from about 5 to about 65% by weight of the one or more of R-1234ze(E), R-152a and R-1234yf.

Advantageously, the compositions of the invention comprise from about 4 to about 18% by weight R-1132a, from about 10 to about 30% by weight R-32, from about 15 to about 45% by weight R-1132(E) and from about 10 to about 65% by weight of the one or more of R-1234ze(E), R-152a and R-1234yf.

Preferably, the compositions of the invention comprise from about 4 to about 16% by weight R-1132a, from about 12 to about 25% by weight R-32, from about 18 to about 45% by weight R-1132(E) and from about 10 to about 65% by weight of the one or more of R-1234ze(E), R-152a and R-1234yf.

As stated above, the one or more of R-1234ze(E), R-152a and R-1234yf are typically present in the compositions of the invention in an amount of from about 1 or about 2 to about 75% by weight, such as from about 5 to about 70% by weight, for example from about 5 to about 65% by weight, preferably from about 10 to about 65% by weight. In a preferred embodiment, “the one or more of R-1234ze(E), R-152a and R-1234yf” is R-1234ze(E) and R-152a, and is present in the compositions of the invention in these weight concentrations. It is to be understood that R-1234yf optionally may be present in these compositions. In another preferred embodiment, “the one or more of R-1234ze(E), R-152a and R-1234yf” is R-1234ze(E) and is present in these amounts in the compositions of the invention. It is to be understood that optionally R-1234yf and/or R-152a may be present in these compositions.

When present, the R-152a is typically included in the compositions of the invention in an amount of from about 1 to about 50% by weight, such as from about 2 to about 40% by weight, for example from about 3 to about 35% by weight, preferably from about 5 to about 30% by weight.

When present together with R-152a, the R-1234ze(E) is typically included in the compositions of the invention in an amount of from about 1 to about 70% by weight, such as from about 2 to about 60% by weight, for example from 3 to 50% by weight or from about 3 to about 45% by weight.

Thus, the compositions of the invention may comprise R-1132a, R-32, R-1132(E), particularly in the amounts described above, and from about 1 to about 70% by weight R-1234ze(E) and from about 1 to about 50% by weight R-152a, such as from about 2 to about 60% by weight R-1234ze(E) and from about 2 to about 40% by weight R-152a, for example from 3 to 50% by weight R-1234ze(E) and from about 3 to about 35% by weight R-152a, preferably from about 3 to 45% by weight R-1234ze(E) and from about 5 to 30% by weight R-152a.

When present, R-1234yf is conveniently included in the compositions of the invention in an amount of from about 1 to about 30% by weight, such as from about 1 to about 20% by weight, for example from about 1 to about 10% by weight, from about 1 to about 5% by weight. It has been surprisingly found that the inclusion of R-1234yf in these amounts ensures that the total generation potential of TFA from unit mass of the composition of the invention is significantly lower than that of the same quantity of R-454B, at the same time allowing for the compositions of the invention to exploit certain advantageous properties, such as increased volumetric refrigeration capacity, reduced temperature glide and/or reduced compressor exit temperature.

Certain preferred compositions of the invention are those comprising R-1132a, R-32, R-1132(E), particularly in the amounts described above, and R-1234ze(E); and those comprising R-1132a, R-32, R-1132(E), particularly in the amounts described above, and R-1234ze(E) and R-152a. For these compositions, it is also particularly preferred that they comprise from 0 to about 10% by weight R-1234yf, such as from 0 to about 5% by weight or substantially no R-1234yf.

For the compositions of the invention comprising R-1132a, R-32, R-1132(E) (particularly in the above-described amounts) and R-1234ze(E), it is preferred that the R-1234ze(E) is present in an amount of from about 10 to about 50% by weight, such as from about 15 to about 45% by weight, preferably from about 20 to about 40% by weight. For these compositions, it is also particularly preferred that they comprise from 0 to about 10% by weight R-1234yf, such as from 0 to about 5% by weight or substantially no R-1234yf.

Thus, certain preferred compositions of the invention comprise from about 1 to about 20% by weight R-1132a, from about 1 to about 50% by weight R-32, from about 1 to about 60% by weight R-1132(E) and from about 10 to about 50% by weight R-1234ze(E).

Conveniently, such compositions comprise from about 2 to about 20% by weight R-1132a, from about 5 to about 45% by weight R-32, from about 5 to about 55% by weight R-1132(E) and from about 10 to about 50% by weight R-1234ze(E), such as from about 15 to about 45% by weight R-1234ze(E).

For example, the compositions of the invention comprise from about 3 to about 20% by weight R-1132a, from about 7 to about 40% by weight R-32, from about 10 to about 50% by weight R-1132(E) and from about 15 to about 45% by weight R-1234ze(E).

Advantageously, the compositions of the invention comprise from about 4 to about 18% by weight R-1132a, from about 10 to about 30% by weight R-32, from about 15 to about 45% by weight R-1132(E) and from about 20 to about 40% by R-1234ze(E).

Preferably, the compositions of the invention comprise from about 4 to about 16% by weight R-1132a, from about 12 to about 25% by weight R-32, from about 18 to about 45% by weight R-1132(E) and from about 20 to about 40% by weight R-1234ze(E).

Any of the above-described compositions may conveniently further comprise carbon dioxide (CO₂). Although the presence of CO₂ generally tends to increase compressor discharge temperature and temperature glide (which may not be desirable), the present inventors have surprisingly found that by including CO₂ in the compositions of the invention, it possible to formulate low GWP blends whose both WCF and WCFF has flammability classified as ‘2L’ under ASHRAE 34 assessment process.

Particularly preferred are the compositions of the invention comprising:
CO₂, R-1132a, R-32, R-1132(E) and R-1234ze(E);
CO₂, R-1132a, R-32, R-1132(E), R-1234ze(E) and R-1234yf;
CO₂, R-1132a, R-32, R-1132(E) and R-1234yf; and
CO₂, R-1132a, R-32, R-1132(E) and R-1234ze(E) and R-152a

When present, the CO₂ is typically included in the compositions of the invention in an amount of from about 1 to about 20% by weight, such as from about 1 or about 2 to about 18% by weight, for example from about 2 to about 16% by weight.

When CO₂ is present in the compositions of the invention, the R-1132a may be included in the composition in an amount of from about 1 to about 20% by weight, such as from about 1 or about 2 to about 18% by weight, for example from about 2 to about 16% by weight.

Thus, the R-1132a and the CO₂ are advantageously present in the compositions of the invention in a combined amount of from about 2 to about 25% by weight, such as from about 3 to about 20% by weight, preferably from about 4 to about 20% by weight.

Accordingly, the compositions of the invention typically comprise R-1132a and CO₂ in a combined amount of from about 2 to about 25% by weight, from about 1 to about 50% by weight R-32, from about 1 to about 60% by weight R-1132(E) and from about 1 or about 2 to about 75% by weight of the one or more of R-1234ze(E), R-152a and R-1234yf.

The compositions of the invention may comprise R-1132a and CO₂ in a combined amount of from about 2 to about 25% by weight (or, conveniently, from about 3 to about 20% by weight), from about 5 to about 45% by weight R-32, from about 5 to about 55% by weight R-1132(E) and from about 5 to about 70% by weight of the one or more of R-1234ze(E), R-152a and R-1234yf.

Conveniently, the compositions of the invention comprise of R-1132a and CO₂ in a combined amount of from about 3 to about 20% by weight, from about 7 to about 40% by weight R-32, from about 10 to about 50% by weight R-1132(E) and from about 5 to about 65% by weight of the one or more of R-1234ze(E), R-152a and R-1234yf.

Advantageously, the compositions of the invention comprise R-1132a and CO₂ in a combined amount of from about 4 to about 20% by weight, from about 10 to about 30% by weight R-32, from about 15 to about 45% by weight R-1132(E) and from about 10 to about 65% by weight of one or more of R-1234ze(E), R-152a and R-1234yf.

Preferably, the compositions of the invention comprise R-1132a and CO₂ in a combined amount of from about 4 to about 20% by weight, from about 12 to about 25% by weight R-32, from about 18 to about 45% by weight R-1132(E) and from about 10 to about 65% by weight of the one or more of R-1234ze(E), R-152a and R-1234yf.

In one embodiment, “the one or more of R-1234ze(E), R-152a and R-1234yf” is (i) R-1234ze(E) and R-152a or (ii) R-1234ze(E) and R-1234yf, and is included in the compositions in the weight concentrations described above in respect of “the one or more of R-1234ze(E), R-152a and R-1234yf”. In a preferred embodiment, “the one or more of R-1234ze(E), R-152a and R-1234yf” is R-1234ze(E) and is present in these amounts. For these compositions, it is also particularly preferred that they comprise from 0 to about 10% by weight R-1234yf, such as from 0 to about 5% by weight or substantially no R-1234yf.

As stated above, the one or more of R-1234ze(E), R-152a and R-1234yf are typically present in the compositions of the invention in an amount of from about 1 to about 75% by weight, such as from about 5 to about 70% by weight, for example from about 5 to about 65% by weight, preferably from about 10 to about 65% by weight.

When present, R-152a is typically included in the compositions of the invention in an amount of from about 1 to about 50% by weight, such as from about 2 to about 40% by weight, for example from about 3 to about 35% by weight, preferably from about 5 to about 30% by weight.

When present together with R-152a, the R-1234ze(E) is typically included in the compositions of the invention in an amount of from about 1 to about 70% by weight, such as from about 2 to about 60% by weight, for example from 3 to 50% by weight or from 3 to 45% by weight.

Thus, the compositions of the invention may comprise CO₂, R-1132a, R-32, R-1132(E), particularly in the amounts described above, and from about 1 to about 70% by weight R-1234ze(E) and from about 1 to about 50% by weight R-152a, such as from about 2 to about 60% by weight R-1234ze(E) and from about 2 to about 40% by weight R-152a, for example from 3 to 50% by weight R-1234ze(E) and from about 3 to about 35% by weight R-152a, preferably from about 3 to 45% by weight R-1234ze(E) and from about 5 to 30% by weight R-152a.

When present, R-1234yf is conveniently included in the compositions of the invention in an amount of from about 1 to about 30% by weight, such as from about 1 to about 20% by weight, for example from about 1 to about 10% by weight, from about 1 to about 5% by weight. It has been surprisingly found that the inclusion of R-1234yf in these amounts ensures that the total generation potential of TFA from unit mass of the composition of the invention is significantly lower than that of the same quantity of R-454B, at the same time allowing for the compositions of the invention to exploit certain advantageous properties, such as increased volumetric refrigeration capacity, reduced temperature glide and/or reduced compressor exit temperature, particularly reduced compressor exit temperature.

As stated above, the more preferred compositions of the invention comprise CO₂, R-1132a, R-32, R-1132(E) and R-1234ze(E). For the compositions of the invention comprising CO₂, R-1132a, R-32, R-1132(E) (particularly in the above-described amounts) and R-1234ze(E), it is preferred that the R-1234ze(E) is present in an amount of from about 10 to about 50% by weight, such as from about 15 to about 45% by weight, preferably from about 20 to about 40% by weight. For these compositions, it is also particularly preferred that they comprise from 0 to about 10% by weight R-1234yf, such as from 0 to about 5% by weight or substantially no R-1234yf.

Such compositions of the invention typically comprise R-1132a and CO₂ in a combined amount of from about 2 to about 25% by weight, from about 1 to about 50% by weight R-32, from about 1 to about 60% by weight R-1132(E) and from about 10 to about 50% by weight R-1234ze(E) (conveniently, from 15 to about 45% by weight R-1234ze(E)).

The compositions of the invention may comprise R-1132a and CO₂ in a combined amount of from about 2 to about 25% by weight (such as from about 3 to about 20% by weight), from about 5 to about 45% by weight R-32, from about 5 to about 55% by weight R-1132(E) and from about 10 to about 50% by weight R-1234ze(E) (such as from about 15 to about 45% by weight R-1234ze(E)).

Conveniently, the compositions of the invention comprise of R-1132a and CO₂ in a combined amount of from about 3 to about 20% by weight, from about 7 to about 40% by weight R-32, from about 10 to about 50% by weight R-1132(E) and from about 15 to about 45% by weight R-1234ze(E).

Advantageously, the compositions of the invention comprise R-1132a and CO₂ in a combined amount of from about 4 to about 20% by weight, from about 10 to about 30% by weight R-32, from about 15 to about 45% by weight R-1132(E) and from about 20 to about 40% by weight R-1234ze(E).

Preferably, the compositions of the invention comprise R-1132a and CO₂ in a combined amount of from about 4 to about 20% by weight, from about 12 to about 25% by weight R-32, from about 18 to about 45% by weight R-1132(E) and from about 20 to about 40% by weight R-1234ze(E).

Certain preferred compositions of the invention comprise CO₂ and R-1132a in a combined amount of from about 6 to about 18% by weight, from about 25 to about 45% by weight of R-1132(E), from about 15 to about 28% by weight R-32 and from about 20 to about 40% by weight R-1234ze(E). Advantageously, the compositions comprise CO₂ and R-1132a in a combined amount of from about 8 to about 14% by weight, from about 30 to about 45% by weight of R-1132(E), from about 18 to about 25% by weight R-32 and from about 25 to about 35% by weight R-1234ze(E).

Any of the above-described compositions may further contain one or more compound(s) selected from the group consisting of 1,1,1,2-tetrafluoroethane (R-134a), isobutane (R-600a), propane (R-290), octafluoropropane (R-218), hexafluoropropylene (R-1216), 1,1,1,2,3,3,3-heptafluoropropane (R-227ea), trifluoroethylene (R-1123), fluoromethane (R-41), 3,3,3-trifluoropropene (R-1243zf) and/or fluoroethane (R-161) and mixtures thereof. Typically, the compositions of the invention contain from about 1 to about 15% by weight of the one or more compound(s), such as from about 1 to about 10% by weight, for example from about 1 to about 5% by weight. Without being bound by theory, it is believed that, when present, the one or more compound(s) may increase vapour pressure of the compositions of the invention and/or increase their volumetric capacity and/or reduce their temperature glide.

In an embodiment, the compositions may consist essentially of the stated components. By the term “consist essentially of”, we include the meaning that the compositions of the invention contain substantially no other components, particularly no further (hydro)(fluoro) compounds (e.g. (hydro)(fluoro) alkanes or (hydro)(fluoro)alkenes) known to be used in heat transfer compositions. The term “consist of” is included within the meaning of “consist essentially of”.

In an embodiment, the compositions of the invention are substantially free of any component that has heat transfer properties other than the components specified. For instance, the compositions of the invention may be substantially free of any other hydrofluorocarbon compound.

By “substantially no” and “substantially free of”, we include the meaning that the compositions of the invention contain 0.5% by weight or less of the stated component, preferably 0.4%, 0.3%, 0.2% or 0.1% or less, based on the total weight of the composition.

In one embodiment, the compositions contain substantially no trifluoroiodomethane (CF₃I).

Preferably, the compositions of the invention comprise substantially no trifluoroethylene (R-1123). Surprisingly, it has been found that such compositions have improved lifetime and chemical stability when used in heat transfer devices.

All of the chemicals herein described are commercially available. For example, the fluorochemicals may be obtained from Apollo Scientific (UK) and carbon dioxide may be obtained from liquefied gas suppliers such as Linde AG.

As used herein, all % amounts mentioned in compositions herein, including in the claims, are by weight based on the total weight of the compositions, unless otherwise stated.

By the term “about”, as used in connection with numerical values of amounts of components in % by weight, we include the meaning of +0.5% by weight, for example ±0.1% by weight.

For the avoidance of doubt, it is to be understood that the stated upper and lower values for ranges of amounts of components in the compositions of the invention described herein may be interchanged in any way, provided that the resulting ranges fall within the broadest scope of the invention.

The compositions of the invention have zero ozone depletion potential.

Typically, the compositions of the invention have Global Warming Potential (GWP) of less than 600. Preferably, the compositions of the invention have a GWP of less than 500, preferably less than 450, such as less than 350, for example less than 300, such as less than 200, preferably less than 150.

Typically, the compositions of the invention are of reduced flammability hazard when compared to R-1132a and R-1132(E) alone.

Flammability may be determined in accordance with ASHRAE Standard 34 incorporating the ASTM Standard E-681 with test methodology as per Addendum 34p dated 2004, the entire content of which is incorporated herein by reference.

In one aspect, the compositions have one or more of (a) a higher lower flammable limit; (b) a higher ignition energy (sometimes referred to as auto ignition energy or pyrolysis); or (c) a lower flame velocity compared to R-1132a and R-1132(E) alone. Preferably, the compositions of the invention are less flammable compared to R-1132a and R-1132(E) in one or more of the following respects: lower flammable limit at 23° C.; lower flammable limit at 60° C.; breadth of flammable range at 23° C. or 60° C.; auto-ignition temperature (thermal decomposition temperature); minimum ignition energy in dry air or flame speed. The flammable limits being determined according to the methods specified in ASHRAE-34 and the auto-ignition temperature being determined in a 500 ml glass flask by the method of ASTM E659-78.

In some applications it may not be necessary for the formulation to be classed as non-flammable by the ASHRAE-34 methodology. It is possible to develop fluids whose flammability limits will be sufficiently reduced in air to render them safe for use in the application, for example if it is physically not possible to make a flammable mixture by leaking the refrigeration equipment charge into the surrounds.

In one embodiment, the compositions of the invention have a flammability classifiable as 2L or 2 according to the ASHRAE standard 34 classification method, indicating a weakly flammable fluid with flame speed lower than 10 cm/s (class 2L) or flammable fluid (class 2).

The flammability of a refrigerant composition is classified by ASHRAE SSPC34 and ISO817 by a complex assessment process. Two compositions are considered: the “Worst Case Formulation” (WCF) and the “Worst Case Formulation for Flammability” (WCFF). The WCF is the composition that has the maximum permitted level of the most flammable species in the blend according to the manufacturing tolerances specified by the blend designer during the application process. The WCFF is the most flammable composition that can arise during vapour leakage of refrigerant from a cylinder or system at any temperature between −40° C. and +60° C.

Typically, at least the WCF of the compositions of the invention has flammability classified as ‘2L’ by ASHRAE-34 assessment process and certain compositions of the invention, as explained above, have both WCF and WCFF have flammability classified as ‘2L’ by ASHRAE-34 assessment process.

It is believed that the compositions of the invention exhibit a completely unexpected combination of low-/non-flammability, low GWP, improved lubricant miscibility and improved refrigeration performance properties. Some of these refrigeration performance properties are explained in more detail below.

The compositions of the invention typically have a coefficient of performance (COP) that is within about 15% of that of R-410A. Advantageously, the COP of the compositions of the invention is within about 10% of that of R-410A, such as within about 7%, for example within about 5%. Preferably, the COP is equivalent or higher than that of R-410A.

The compositions of the invention typically have a volumetric refrigeration capacity that is within about 25% of that of R-410A. Advantageously, the compositions of the invention have a volumetric refrigeration capacity that is within about 20% of that of R-410A, such as within about 15 or about 10%, preferably within about 5%.

The compositions of the invention typically have a compressor discharge temperature that is within about 25K of that of R-410A. Preferably, the compositions of the invention have a compressor discharge temperature that is within about 20K of that of R-410A, such as within about 15K.

Typically, the compositions of the invention have a temperature glide in an evaporator or condenser of less than about 20K. Advantageously, the compositions of the invention have a temperature glide in an evaporator or condenser of less than about 15K, preferably less than about 10K.

The compositions of the invention typically have a critical temperature that is within about 15% of that of R-410A. Advantageously, the compositions of the invention have a critical temperature that is equivalent to or higher than that of R-410A.

Conveniently, the compositions of the invention have a burning velocity of less than about 10 cm/s as measured by ASHRAE Standard 34.

Typically, the compositions of the invention have a total generation potential of TFA from unit mass of the composition which is less than that of the equivalent mass of R-454B, such as 75% or less, for example 50% or less, preferably 10% or less.

The compositions of the invention are typically suitable for use in existing designs of equipment and are compatible with all classes of lubricant currently used with established HFC refrigerants. They may be optionally stabilised or compatibilised with mineral oils (e.g. lubricants) by the use of appropriate additives, such as polyol esters (POEs), for example POEs with a viscosity of about 7 to 32 cSt at about 40° C.

Therefore, in one aspect, the composition of the invention is combined with a lubricant, particularly, when used in heat transfer equipment.

Conveniently, the lubricant is selected from the group consisting of mineral oil, silicone oil, polyalkyl benzenes (PABs), polyol esters (POEs), polyalkylene glycols (PAGs, also known as polyethers), polyalkylene glycol esters (PAG esters), polyvinyl ethers (PVEs), poly (alpha-olefins) and combinations thereof. PAGs and POEs are currently preferred lubricants for the compositions of the invention.

Advantageously, the lubricant further comprises a stabiliser. In a similar aspect, the composition of the invention may be combined with a stabiliser.

Preferably, the stabiliser is selected from the group consisting of diene-based compounds, phosphates, phenol compounds (such as 2,6-Di-tert-butyl-4-methylphenol) and epoxides, and mixtures thereof.

Conveniently, the composition of the invention may be combined with a flame retardant.

Advantageously, the flame retardant is selected from the group consisting of tri-(2-chloroethyl)-phosphate, (chloropropyl) phosphate, tri-(2,3-dibromopropyl)-phosphate, tri-(1,3-dichloropropyl)-phosphate, diammonium phosphate, various halogenated aromatic compounds, antimony oxide, aluminium trihydrate, polyvinyl chloride, a fluorinated iodocarbon, a fluorinated bromocarbon, trifluoro iodomethane, perfluoroalkyl amines, bromo-fluoroalkyl amines and mixtures thereof.

In another aspect of the invention, there is provided a heat transfer device comprising a composition of the invention. Preferably, the heat transfer device is a refrigeration device.

Conveniently, the heat transfer device is a residential or commercial air conditioning system, a heat pump or a commercial or industrial refrigeration system.

The invention also provides the use of a composition of the invention in a heat transfer device, such as a refrigeration system, as herein described.

According to a further aspect of the invention, there is provided a method for cooling an article which comprises condensing a composition of the invention and thereafter evaporating said composition in the vicinity of the article to be cooled.

According to another aspect of the invention, there is provided a method for heating an article which comprises condensing a composition of the invention in the vicinity of the article to be heated and thereafter evaporating said composition.

The compositions of the invention may also be prepared simply by mixing the R-1132a, R-32, R-1132(E) and the one or more of R-1234ze(E), R-152a and R-1234yf (and optional components such as R-744, a lubricant, a stabiliser or an additional flame retardant) in the desired proportions. The compositions can then be added to a heat transfer device (or used in any other way as defined herein).

In one aspect, there is provided the use of a composition of the invention as a replacement for a refrigerant in a heat transfer device. Conveniently, the refrigerant is selected from R-410A, R-454B, R-452B and R-32 and preferably is R-410A. Advantageously, the heat transfer device comprises a residential or commercial air conditioning system, a heat pump or a commercial or industrial refrigeration system.

According to another aspect of the invention, there is provided a sprayable composition comprising a material to be sprayed and a propellant comprising a composition of the invention.

According to a further aspect of the invention, there is provided a method for extracting a substance from biomass comprising contacting the biomass with a solvent comprising a composition of the invention, and separating the substance from the solvent.

According to another aspect of the invention, there is provided a method of cleaning an article comprising contacting the article with a solvent comprising a composition of the invention.

According to a further aspect of the invention, there is provided a method for extracting a material from an aqueous solution comprising contacting the aqueous solution with a solvent comprising a composition of the invention, and separating the material from the solvent.

According to another aspect of the invention, there is provided a method for extracting a material from a particulate solid matrix comprising contacting the particulate solid matrix with a solvent comprising a composition of the invention, and separating the material from the solvent.

According to a further aspect of the invention, there is provided a mechanical power generation device containing a composition of the invention.

Preferably, the mechanical power generation device is adapted to use a Rankine Cycle or modification thereof to generate work from heat.

According to another aspect of the invention, there is provided a method of retrofitting a heat transfer device comprising the step of removing an existing heat transfer fluid, and introducing a composition of the invention. Preferably, the heat transfer device is a refrigeration device, such as a unitary air-conditioning and/or heat pump system.

Advantageously, the method further comprises the step of obtaining an allocation of greenhouse gas (e.g. carbon dioxide) emission credit.

In accordance with the retrofitting method described above, an existing heat transfer fluid can be fully removed from the heat transfer device before introducing a composition of the invention. An existing heat transfer fluid can also be partially removed from a heat transfer device, followed by introducing a composition of the invention.

In a further aspect of the invention, there is provided a method for reducing the environmental impact arising from operation of a product comprising an existing compound or composition, the method comprising replacing at least partially the existing compound or composition with a composition of the invention.

By environmental impact we include the generation and emission of greenhouse warming gases through operation of the product.

As mentioned above, this environmental impact can be considered as including not only those emissions of compounds or compositions having a significant environmental impact from leakage or other losses, but also including the emission of carbon dioxide arising from the energy consumed by the device over its working life. Such environmental impact may be quantified by the measure known as Total Equivalent Warming Impact (TEWI). This measure has been used in quantification of the environmental impact of certain stationary refrigeration and air conditioning equipment, including for example supermarket refrigeration systems.

The environmental impact may further be considered as including the emissions of greenhouse gases arising from the synthesis and manufacture of the compounds or compositions. In this case the manufacturing emissions are added to the energy consumption and direct loss effects to yield the measure known as Life-Cycle Carbon Production (LCCP). The use of LCCP is common in assessing environmental impact of automotive air conditioning systems.

In a preferred embodiment, the use of the composition of the invention results in the equipment having a lower Total Equivalent Warming Impact, and/or a lower Life-Cycle Carbon Production than that which would be attained by use of the existing compound or composition.

These methods may be carried out on any suitable product, for example in the fields of air-conditioning, refrigeration, heat transfer, aerosols or sprayable propellants, gaseous dielectrics, flame suppression, solvents (e.g. carriers for flavorings and fragrances), cleaners, topical anesthetics, and expansion applications. Preferably, the field is refrigeration.

Examples of suitable products include heat transfer devices, sprayable compositions, solvents and mechanical power generation devices. In a preferred embodiment, the product is a heat transfer device, such as a refrigeration device.

The existing compound or composition has an environmental impact as measured by GWP and/or TEWI and/or LCCP that is higher than the composition of the invention which replaces it. The existing compound or composition may comprise a fluorocarbon compound, such as a perfluoro-, hydrofluoro-, chlorofluoro- or hydrochlorofluoro-carbon compound or it may comprise a fluorinated olefin.

Preferably, the existing compound or composition is a heat transfer compound or composition such as a refrigerant. Examples of refrigerants that may be replaced include R-410A, R454B, R-452B and R-32, preferably R-410A.

Any amount of the existing compound or composition may be replaced so as to reduce the environmental impact. This may depend on the environmental impact of the existing compound or composition being replaced and the environmental impact of the replacement composition of the invention. Preferably, the existing compound or composition in the product is fully replaced by the composition of the invention.

The invention will now be described with reference to the following, non-limiting examples.

### EXAMPLES

A thermodynamic property model was constructed using the NIST REFPROP 9.1 software package. This was used to model refrigeration cycle performance for an idealised vapour compression cycle, using the performance of R-410A as a reference fluid. The cycle conditions assumed for this modelling are set out in Table 1, while the modelling results for R-410A are summarised in Table 2 below.

TABLE 1

| (Modelling cycle conditions) | | R-410A |
|---|---|---|
| Cooling duty | kW | 17.6 |
| Mean condenser temperature | °C. | 54.4 |
| Mean evaporator temperature | °C. | 7.2 |
| Condenser subcooling | K | 8.3 |
| Evaporator superheat | K | 5.6 |
| Evaporator pressure drop | bar | 0.0 |
| Suction line pressure drop | bar | 0.0 |
| Condenser pressure drop | bar | 0.0 |
| Compressor suction superheat | K | 11.1 |
| Isentropic efficiency | | 70.0% |

TABLE 2

| (Modelling results for R-410A) | | R-410A |
|---|---|---|
| Cooling COP | | 2.88 |
| Cooling COP relative to Reference | | 100.0% |
| Volumetric cooling capacity | KJ/m³ | 5260 |
| Cooling Capacity relative to Reference | | 100.0% |
| Compressor discharge temperature | °C. | 103.0 |
| Discharge temperature difference from reference | K | 0.0 |
| Evaporator inlet pressure | bar | 10.00 |
| Condenser inlet pressure | bar | 33.93 |
| Evaporator glide (out-in) | K | 0.1 |
| Condenser glide (in-out) | K | 0.1 |
| Average Temperature glide | K | 0.1 |

The performance of selected compositions of the invention was then modelled using R-410A as a reference (ref.). The results are summarised in the following tables. Surprisingly, it has been found that the properties of the compositions of the invention could be considered sufficiently close to those of R-410A to allow their ready adoption in existing R-410A-based designs of components and pipework. The following properties are thought to be particularly desirable in this context:
(a) Energy efficiency (expressed as COP) within 10% of R-410A;
(b) Volumetric cooling capacity within about 20% of that of R-410A;
(c) Compressor discharge temperature within about 15K of the R-410A values;
(d) Average temperature glide (temperature change during evaporation/condensation processes) in evaporator and condenser lower than 15K;
(e) Critical temperature of refrigerant like or higher than that of R-410A (71.4° C.);
(f) Total potential generation of trifluoroacetic acid from unit mass of the refrigerant blend to be lower than the equivalent from the same quantity of R-454B.

Other compositions which offer acceptable operating pressure and flammability but which do not meet all of these criteria may also give acceptable performance in suitably designed new equipment. For example, blends having volumetric capacity of less than 80% that of R-410A could be used by increasing compressor displacement or compressor speed. Blends having larger temperature glide than 15K could be used by employing cross-counterflow heat exchanger designs of condenser and/or evaporator. Blends which have good performance characteristics but which exhibit class 2 flammability may also be used in systems where the charge size and application conditions make it safe for use.

TABLE 1
Results

| | | | R-744 | | | | |
|---|---|---|---|---|---|---|---|
| | | | 0% | 3% | 3% | 3% | 3% |
| | | | R-1132a | | | | |
| | | | 6% | 3% | 3% | 3% | 3% |
| | | | R-1132(E) | | | | |
| | | | 30% | 20% | 30% | 40% | 50% |
| | | | R-32 | | | | |
| | | | 21% | 21% | 21% | 21% | 21% |
| | | | R-1234ze(E) | | | | |
| | | R-410A | 46% | 53% | 43% | 33% | 23% |
| Cooling COP | | 2.88 | 2.99 | 3.03 | 2.97 | 2.92 | 2.87 |
| Cooling COP relative to ref. | | 100.0% | 103.9% | 105.3% | 103.4% | 101.5% | 99.8% |
| Volumetric cooling capacity | kJ/m³ | 5260 | 4419 | 4244 | 4584 | 4916 | 5247 |
| Cooling Capacity relative to ref. | | 100.0% | 84.0% | 80.7% | 87.1% | 93.5% | 99.7% |
| Compressor discharge temperature | ° C. | 103.0 | 107.0 | 107.2 | 109.4 | 111.3 | 112.7 |
| Discharge temperature difference from | K | 0.0 | 4.0 | 4.2 | 6.4 | 8.3 | 9.7 |
| ref. | | | | | | | |
| Evaporator inlet pressure | bar | 10.00 | 7.78 | 7.22 | 8.03 | 8.87 | 9.75 |
| Condenser inlet pressure | bar | 33.93 | 27.9 | 26.7 | 29.1 | 31.5 | 33.9 |
| Evaporator glide (out-in) | K | 0.1 | 10.1 | 12.1 | 11.0 | 9.4 | 7.4 |
| Condenser glide (in-out) | K | 0.1 | 9.5 | 12.9 | 11.0 | 8.9 | 6.7 |
| Average Temperature glide | K | 0.1 | 9.8 | 12.5 | 11.0 | 9.1 | 7.1 |

| | | R-744 | | | |
|---|---|---|---|---|---|
| | | 0% | 4% | 4% | 4% |
| | | R-1132a | | | |
| | | 8% | 4% | 4% | 4% |
| | | R-1132(E) | | | |
| | | 30% | 20% | 30% | 40% |
| | | R-32 | | | |
| | | 21% | 21% | 21% | 21% |
| | | R-1234ze(E) | | | |
| | | 41% | 51% | 41% | 31% |
| Cooling COP | | 2.96 | 3.00 | 2.94 | 2.89 |
| Cooling COP relative to ref. | | 102.9% | 104.2% | 102.2% | 100.3% |
| Volumetric cooling capacity | kJ/m³ | 4545 | 4427 | 4765 | 5097 |
| Cooling Capacity relative to ref. | | 86.4% | 84.2% | 90.6% | 96.9% |
| Compressor discharge temperature | ° C. | 107.6 | 108.7 | 110.8 | 112.5 |
| Discharge temperature difference from | K | 4.6 | 5.7 | 7.8 | 9.5 |
| ref. | | | | | |
| Evaporator inlet pressure | bar | 8.10 | 7.61 | 8.45 | 9.32 |
| Condenser inlet pressure | bar | 29.0 | 28.1 | 30.5 | 33.0 |
| Evaporator glide (out-in) | K | 10.4 | 12.9 | 11.5 | 9.8 |
| Condenser glide (in-out) | K | 9.6 | 13.6 | 11.5 | 9.2 |
| Average Temperature glide | K | 10.0 | 13.2 | 11.5 | 9.5 |

TABLE 2
Results

| | | | R-744 | | | | |
|---|---|---|---|---|---|---|---|
| | | | 4% | 6% | 6% | 6% | 6% |
| | | | R-1132a | | | | |
| | | | 4% | 6% | 6% | 6% | 6% |
| | | | R-1132(E) | | | | |
| | | | 50% | 20% | 30% | 40% | 50% |
| | | | R-32 | | | | |
| | | | 21% | 21% | 21% | 21% | 21% |
| | | | R-1234ze(E) | | | | |
| | | R-410A | 21% | 47% | 37% | 27% | 17% |
| Cooling COP | | 2.88 | 2.84 | 2.93 | 2.87 | 2.82 | 2.77 |
| Cooling COP relative to ref. | | 100.0% | 98.6% | 102.0% | 99.9% | 97.9% | 96.1% |
| Volumetric cooling capacity | kJ/m³ | 5260 | 5428 | 4788 | 5123 | 5453 | 5783 |
| Cooling Capacity relative to ref. | | 100.0% | 103.2% | 91.0% | 97.4% | 103.7% | 109.9% |
| Compressor discharge temperature | ° C. | 103.0 | 113.7 | 111.4 | 113.2 | 114.5 | 115.5 |
| Discharge temperature difference from | K | 0.0 | 10.8 | 8.4 | 10.2 | 11.5 | 12.5 |
| ref. | | | | | | | |
| Evaporator inlet pressure | bar | 10.00 | 10.23 | 8.43 | 9.32 | 10.25 | 11.22 |
| Condenser inlet pressure | bar | 33.93 | 35.5 | 30.9 | 33.5 | 36.0 | 38.6 |
| Evaporator glide (out-in) | K | 0.1 | 7.6 | 14.1 | 12.4 | 10.3 | 7.9 |
| Condenser glide (in-out) | K | 0.1 | 6.9 | 14.5 | 12.0 | 9.4 | 7.0 |
| Average Temperature glide | K | 0.1 | 7.3 | 14.3 | 12.2 | 9.9 | 7.4 |

| | | R-744 | | | |
|---|---|---|---|---|---|
| | | 8% | 8% | 8% | 8% |
| | | R-1132a | | | |
| | | 8% | 8% | 8% | 8% |
| | | R-1132(E) | | | |
| | | 20% | 30% | 40% | 50% |
| | | R-32 | | | |
| | | 21% | 21% | 21% | 21% |
| | | R-1234ze(E) | | | |
| | | 43% | 33% | 23% | 13% |
| Cooling COP | | 2.87 | 2.80 | 2.74 | 2.69 |
| Cooling COP relative to ref. | | 99.7% | 97.4% | 95.4% | 93.6% |
| Volumetric cooling capacity | kJ/m³ | 5141 | 5471 | 5797 | 6126 |
| Cooling Capacity relative to ref. | | 97.7% | 104.0% | 110.2% | 116.5% |
| Compressor discharge temperature | ° C. | 113.7 | 115.2 | 116.3 | 116.8 |
| Discharge temperature difference from | K | 10.7 | 12.2 | 13.3 | 13.8 |
| ref. | | | | | |
| Evaporator inlet pressure | bar | 9.30 | 10.25 | 11.24 | 12.28 |
| Condenser inlet pressure | bar | 33.8 | 36.5 | 39.1 | 41.7 |
| Evaporator glide (out-in) | K | 14.9 | 12.9 | 10.5 | 7.8 |
| Condenser glide (in-out) | K | 14.7 | 11.9 | 9.2 | 6.6 |
| Average Temperature glide | K | 14.8 | 12.4 | 9.8 | 7.2 |

1. A composition comprising:
(a) 1,1-difluoroethylene (R-1132a);
(b) difluoromethane (R-32);
(c) trans-1,2-difluoroethylene (R-1132(E)); and
(d) one or more of trans-1,3,3,3-tetrafluoropropene (R-1234ze(E)), 1,1-difluoroethane (R-152a) and 2,3,3,3-tetrafluoropropene (R-1234yf).

2. The composition according to claim 1, wherein the R-1132a is present in an amount of from about 1 to about 20% by weight, from about 2 to about 20% by weight, from about 3 to about 20% by weight, from about 4 to about 18% by weight, or from about 4 to about 16% by weight.

3. The composition according to claim 1, wherein the R-32 is present in an amount of from about 1 to about 50% by weight, from about 5 to about 45% by weight, from about 7 to about 40% by weight, from about 10 to about 30% by weight, or from about 12 to about 25% by weight.

4. The composition according to claim 1, wherein the R-1132(E) is present in an amount of from about 1 to about 60% by weight, from about 5 to about 55% by weight, from about 10 to about 50% by weight, from about 15 to about 45% by weight, or from about 18 to about 45% by weight.

5. The composition according to claim 1, wherein the one or more of R-1234ze(E), R-152a and R-1234yf is present in an amount of from about 1 to about 75% by weight, from about 5 to about 70% by weight, from about 5 to about 65% by weight, from about 10 to about 65% by weight, and optionally the composition comprises from about 1 to about 75% by weight of R-1234ze(E), or R-1234ze(E) and R-152a in a combined content of from about 1 to about 75% by weight.

6. The composition according to claim 1 comprising from about 1 to about 20% by weight R-1132a, from about 1 to about 50% by weight R-32, from about 1 to about 60% by weight R-1132(E) and from about 1 to about 75% by weight of the one or more of R-1234ze(E), R-152a and R-1234yf, and optionally from about 1 to about 75% by weight of R-1234ze(E); or R-1234ze(E) and R-152a in a combined content of from about 1 to about 75% by weight.

7. The composition according to claim 1 comprising:
from about 2 to about 20% by weight R-1132a, from about 5 to about 45% by weight R-32, from about 5 to about 55% by weight R-1132(E) and from about 5 to about 70% by weight of the one or more of R-1234ze(E), R-152a and R-1234yf;
from about 3 to about 20% by weight R-1132a, from about 7 to about 40% by weight R-32, from about 10 to about 50% by weight R-1132(E) and from about 5 to about 65% by weight of the one or more of R-1234ze(E), R-152a and R-1234yf; or
from about 4 to about 18% by weight R-1132a, from about 10 to about 30% by weight R-32, from about 15 to about 45% by weight R-1132(E) and from about 10 to about 65% by weight of the one or more of R-1234ze(E), R-152a and R-1234yf.

8. The composition according to claim 1 comprising R-1132a, R-32, R-1132(E) and R-1234ze(E), wherein the R-1234ze(E) is present in an amount of from about 10 to about 50% by weight, from about 15 to about 45% by weight, or from about 20 to about 40% by weight.

9. The composition according to claim 8 comprising:
from about 1 to about 20% by weight R-1132a, from about 1 to about 50% by weight R-32, from about 1 to about 60% by weight R-1132(E) and from about 10 to about 50% by weight R-1234ze(E);
from about 2 to about 20% by weight R-1132a, from about 5 to about 45% by weight R-32, from about 5 to about 55% by weight R-1132(E) and from about 10 to about 50% by weight R-1234ze(E); or
from about 3 to about 20% by weight R-1132a, from about 7 to about 40% by weight R-32, from about 10 to about 50% by weight R-1132(E) and from about 15 to about 45% by weight R-1234ze(E).

10. The composition according to claim 1, wherein the R-152a is present in an amount of from about 1 to about 50% by weight, from about 2 to about 40% by weight, or from about 3 to about 35% by weight.

11. The composition according to claim 10, wherein the R-1234ze(E) is present in an amount of from about 1 to about 60% by weight, 2 to about 50% by weight, or from about 3 to about 45% by weight.

12. The composition according to claim 1, wherein the R-1234yf is present in an amount of from about 1 to about 30% by weight, from about 1 to about 20% by weight, from about 1 to about 10% by weight, or from 1 to about 5% by weight.

13. The composition according to claim 1, wherein the composition further comprises carbon dioxide (CO₂).

14. The composition according to claim 13, wherein the CO₂ is present in an amount of from about 1 to about 20% by weight, from about 1 to about 18% by weight, from about 2 to about 18% by weight, or from about 2 to about 16% by weight.

15. The composition according to claim 13, wherein the R-1132a and the CO₂ are present in a combined amount of from about 3 to about 25% by weight, from about 3 to about 20% by weight, or from about 4 to about 20% by weight.

16. The composition according to claim 13, wherein the one or more of R-1234ze(E), R-152a and R-1234yf is present in an amount of from about 1 to about 75% by weight, from about 5 to about 70% by weight, from about 5 to about 65% by weight, or from about 10 to about 65% by weight, and optionally from about 1 to about 75% by weight R-1234ze(E); or R-1234ze(E) and R-152a in a combined content of from about 1 to about 75% by weight; or from about 1 to about 75% by weight R-1234yf.

17. The composition according to claim 13 comprising:
R-1132a and CO₂ in a combined amount of from about 2 to about 25% by weight, from about 1 to about 50% by weight R-32, from about 1 to about 60% by weight R-1132(E) and from about 10 to about 50% by weight R-1234ze(E);
R-1132a and CO₂ in a combined amount of from about 2 to about 25% by weight, from about 5 to about 45% by weight R-32, from about 5 to about 55% by weight R-1132(E) and from about 10 to about 50% by weight R-1234ze(E); or
R-1132a and CO₂ in a combined amount of from about 3 to about 20% by weight, from about 7 to about 40% by weight R-32, from about 10 to about 50% by weight R-1132(E) and from about 15 to about 45% by weight R-1234ze(E).

18. The composition according to claim 13 comprising CO₂ and R-1132a in a combined amount of from about 6 to about 18% by weight, from about 25 to about 45% by weight of R-1132(E), from about 15 to about 28% by weight R-32 and from about 20 to about 40% by weight R-1234ze(E).

19. The composition according to claim 1 consisting essentially of the stated components.

20. The composition according to claim 1, wherein the composition has a Global Warming Potential (GWP) of less than 450, such as less than 350, for example less than 300, such as less than 200, preferably less than 150.

21. The composition according to claim 1, wherein the composition is less flammable than R-1132a and/or R-1132(E) alone.

22. The composition according to claim 21 wherein the composition has:
a. a higher lower flammable limit;
b. a higher ignition energy; and/or
c. a lower flame velocity;
compared to R-1132a and/or R-1132(E) alone.

23. The composition according to claim 1 wherein the composition has a coefficient of performance (COP) that is within about 10% of that of R-410A, within about 7%, within about 5%, or wherein the COP is equivalent or higher than that of R-410A.

24. The composition according to claim 1 wherein the composition has a volumetric refrigeration capacity that is within about 20% of that of R-410A, such as within about 10%, for example within about 5%.

25. The composition according to claim 1 wherein the composition has a compressor discharge temperature that is within about 20K of that of R-410A, or within about 15K.

26. The composition according to claim 1 wherein the composition has a temperature glide in an evaporator or condenser of less than about 15K, or less than about 10K.

27. The composition according to claim 1 wherein the composition has a critical temperature that is equivalent to or higher than that of R-410A.

28. The composition according to claim 1 wherein the composition has a burning velocity of less than about 10 cm/s as measured by ASHRAE Standard 34.

29. The composition comprising a lubricant and a composition according to claim 1 further comprising a lubricant, wherein the lubricant is selected from mineral oil, silicone oil, polyalkyl benzenes (PABs), polyol esters (POEs), polyalkylene glycols (PAGs), polyalkylene glycol esters (PAG esters), polyvinyl ethers (PVEs), poly (alpha-olefins) and combinations thereof, or wherein the lubricant is selected from PAGs or POEs.

30. The composition according to claim 1 further comprising a stabiliser, wherein the stabiliser is selected from diene-based compounds, phosphates, phenol compounds (such as 2,6-Di-tert-butyl-4-methylphenol) and epoxides, and mixtures thereof.

31. The composition according to claim 1 further comprising a flame retardant, wherein the flame retardant is selected from the group consisting of tri-(2-chloroethyl)-phosphate, (chloropropyl) phosphate, tri-(2,3-dibromopropyl)-phosphate, tri-(1,3-dichloropropyl)-phosphate, diammonium phosphate, various halogenated aromatic compounds, antimony oxide, aluminium trihydrate, polyvinyl chloride, a fluorinated iodocarbon, a fluorinated bromocarbon, trifluoro iodomethane, perfluoroalkyl amines, bromo-fluoroalkyl amines and mixtures thereof.

32. A heat transfer device containing a composition as defined in claim 1, wherein the heat transfer device is a refrigeration device, or wherein the heat transfer device comprises a residential or commercial air conditioning system, a heat pump or a commercial or industrial refrigeration system.

33. (canceled)

34. A method for cooling an article which comprises condensing a composition defined in claim 1 and thereafter evaporating the composition in the vicinity of the article to be cooled.

35. A method for heating an article which comprises condensing a composition as defined in claim 1 in the vicinity of the article to be heated and thereafter evaporating the composition.

36. A method for modifying a heat transfer device, the method comprising introducing a composition as defined in claim 1 as a replacement for a refrigerant in the heat transfer device, wherein the refrigerant is selected from R-410A, R-454B, R-452B and R-32, optionally wherein the heat transfer device comprises a residential or commercial air conditioning system, a heat pump or a commercial or industrial refrigeration system.

37. A mechanical power generation device containing a composition as defined in claim 1, wherein the device is adapted to use a Rankine Cycle or modification thereof to generate work from heat.

38. A method of retrofitting a heat transfer device comprising the step of removing an existing heat transfer composition, and introducing a composition as defined in claim 1, wherein the heat transfer device is a commercial or industrial refrigeration device, a heat pump, or a residential or commercial air conditioning system.

39. A method for reducing the environmental impact arising from the operation of a product comprising an existing compound or composition, the method comprising replacing at least partially the existing compound or composition with a composition as defined in claim 1, wherein the the method results in a lower Total Equivalent Warming Impact, and/or a lower Life-Cycle Carbon Production than is attained by use of the existing compound or composition.

40. The method of claim 39 carried out on a product from the fields of air-conditioning, refrigeration, heat transfer, aerosols or sprayable propellants, gaseous dielectrics, flame suppression, solvents, cleaners, topical anesthetics, and expansion applications, optionally wherein the product is selected from a heat transfer device, a sprayable composition, a solvent or a mechanical power generation device, or optionally wherein the product is a heat transfer device, comprising a residential or commercial air conditioning system, a heat pump or a commercial or industrial refrigeration system.

41. The method according to claim 39 wherein the existing compound or composition is a heat transfer composition, wherein the heat transfer composition is a refrigerant selected from R-410A, R-454B, R-452B and R-32.
